(19) United States
(12) Patent Application Publication
(10) Pub. No.: US 2023/0196292 A1
(43) Pub. Date: Jun. 22, 2023

(54) PLANNING METHOD AND PLANNING APPARATUS FOR PRODUCTION CAPACITY ALLOCATION

(71) Applicant: Wistron Corporation, New Taipei City (TW)

(72) Inventors: Liang-Xuan Chen, New Taipei City (TW); Hongwei Li, New Taipei City (TW); WenTong Zhao, New Taipei City (TW); Peng Wu, New Taipei City (TW); Guan-He Wu, New Taipei City (TW); Hsien-Hung Shih, New Taipei City (TW)

(73) Assignee: Wistron Corporation, New Taipei City (TW)

(21) Appl. No.: 17/677,901

(22) Filed: Feb. 22, 2022

(30) Foreign Application Priority Data
Dec. 17, 2021 (CN) 202111549348.2

(51) Int. Cl. G06Q 10/10; G06Q 10/06

(52) U.S. Cl. CPC G06Q 10/103; G06Q 10/06315; G06Q 10/06311; G06Q 10/067

(57) ABSTRACT

A planning method and a planning apparatus for production capacity allocation are provided. A restriction function is set based on multiple related parameters of multiple lines relative to multiple models, an available production capacity of each of the lines, and an order requirement corresponding to the models. A target function is set based on a production capacity target, wherein the production capacity target includes a minimum production cost. A solution module is constructed based on the restriction function and the target function. A production capacity allocation result is obtained through the solution module, wherein the production capacity allocation result includes a line corresponding to a specified model, a headcount of each of the lines, and a number of shifts of each of the lines.

### CROSS-REFERENCE TO RELATED APPLICATION

This application claims the priority benefit of China application serial no. 202111549348.2, filed on Dec. 17, 2021. The entirety of the above-mentioned patent application is hereby incorporated by reference herein and made a part of this specification.

### BACKGROUND

### Technical Field

The disclosure relates to a scheduling and planning mechanism, and particularly relates to a planning method and a planning apparatus for production capacity allocation.

### Description of Related Art

At present, during the manufacturing process of electronic parts, industrial engineers need to plan the production capacities of surface mount members (for example, by adopting a surface mount technology (SMT) process), plug-ins (for example, by adopting a dual in-line package (DIP) process), and assemblies (for example, final assembly (FA)). When a model may be arranged for production on at least one line, various combinations are presented. For example, assuming that 145 models are arranged to be produced in the plug-in segment in February, and in the case where each model may be arranged to be produced in two lines, there will be 2¹⁴⁵ possible production combinations. Therefore, it is a very difficult task for the industrial engineers to find the optimal set of production plans in such a huge amount of production combinations. In actual operations, when the industrial engineers are faced with each production capacity planning task, the production is usually arranged according to the rule of thumb, so it is impossible to ensure whether the production capacity planning is the optimal arrangement.

### SUMMARY

The disclosure provides a planning method and a planning apparatus for production capacity allocation, which can find an optimal production capacity allocation result according to a production capacity target to ensure a reasonable arrangement of resources.

The planning method for production capacity allocation of the disclosure is executed through a processor. The planning method includes the following steps. A restriction function is set based on multiple related parameters of multiple lines relative to multiple models, an available production capacity of each of the lines, and an order requirement corresponding to the models. A target function is set based on a production capacity target. The production capacity target includes a minimum production cost. A solution module is constructed based on the restriction function and the target function. A production capacity allocation result is obtained through the solution module. The production capacity allocation result includes a line corresponding to a specified model, a headcount of each of the lines, and a number of shifts of each of the lines.

In an embodiment of the disclosure, the related parameters include a headcount, a takt time, and an output of each of the lines corresponding to different models. The available production capacity includes a production site to which each of the lines belongs, a number of pilot run days, and a number of working days. The order requirement includes the requested specified model and a corresponding production capacity forecast. The restriction function includes a line distribution restriction, an output restriction, and a line usage rate restriction.

In an embodiment of the disclosure, before setting the restriction function, the planning method further includes the following steps. A project, operation summary data, pilot run data, and productivity data are obtained via a user interface or a database. The requested specified model is obtained from the project, and the production capacity forecast corresponding to the specified model is obtained from the operation summary data based on the specified model. A line correspondingly used by the specified model and the headcount are obtained from the operation summary data, and the corresponding takt time and the output are calculated based on the line correspondingly used by the specified model and the headcount. A productivity and the number of working days corresponding to each of the models are obtained from the productivity data. The number of pilot run days corresponding to the line correspondingly used by the specified model is obtained from the pilot run data.

In an embodiment of the disclosure, the minimum production cost includes line headcount minimization or line number of shifts minimization.

In an embodiment of the disclosure, the production capacity target further includes at least one of a highest production efficiency and a highest per capita unit production.

In an embodiment of the disclosure, the planning method further includes the following steps. At least one tolerance factor is introduced into the restriction function, and a corresponding penalty value is set in the target function.

In an embodiment of the disclosure, the step of setting the restriction function further includes the following steps. A cluster label is set for each of the lines. The lines belonging to a same cluster label are allowed to open a work shift together. A production allocation quantity produced on each of the lines corresponding to the requested specified model is set to not exceed a production capacity forecast of the specified model, and a sum of the production allocation quantities of all of the lines corresponding to the requested specified model is set to be equal to the production capacity forecast. A line usage rate sum of the lines belonging to the same cluster label is set. A largest one among multiple headcounts on the lines belonging to the same cluster label is set to be selected as a headcount representative representing the cluster label.

The planning apparatus for production capacity allocation of the disclosure includes a storage device and a processor. The storage device includes a database. The database stores multiple related parameters of multiple lines relative to multiple models, an available production capacity of each of the lines, and an order requirement corresponding to the models. The processor is coupled to the storage device and is configured to perform the following. A restriction function is set based on the related parameters, the available production capacity of each of the lines, and the order requirement. A target function is set based on a production capacity target. The production capacity target includes a minimum production cost. A solution module is constructed based on the restriction function and the target function. A production capacity allocation result is obtained through the solution module. The production capacity allocation result includes a line corresponding to the requested specified model, a headcount of each of the lines, and a number of shifts of each of the lines.

The planning method for production capacity allocation of the disclosure includes the following steps. Multiple selectable fields are provided via a user interface to obtain multiple data from the selectable fields. The data include multiple related parameters of multiple lines relative to multiple models, an available production capacity of each of the lines, an order requirement corresponding to the models, and a production capacity target. A production capacity allocation result corresponding to the obtained data is displayed through the user interface. The production capacity allocation result includes a line corresponding to a specified model, a headcount of each of the lines, and a number of shifts of each of the lines. After obtaining the data via the user interface, following steps are executed through the processor. A restriction function is set based on the related parameters, the available production capacity, and the order requirement. A target function is set based on the production capacity target. The production capacity target includes a minimum production cost. A solution module is constructed based on the restriction function and the target function. The production capacity allocation result is obtained through the solution module.

Based on the above, the disclosure can promptly re-plan and solve to improve service standards in response to changes in the order requirement of the customer or related specified production conditions.

### BRIEF DESCRIPTION OF THE DRAWINGS

FIG. 1 is a block diagram of a planning apparatus for production capacity allocation according to an embodiment of the disclosure.

FIG. 2 is a flowchart of a planning method for production capacity allocation according to an embodiment of the disclosure.

FIG. 3 is a schematic diagram of data consolidation according to an embodiment of the disclosure.

FIG. 4 is a schematic diagram of a user interface according to an embodiment of the disclosure.

FIG. 5 is a histogram of a production capacity forecast corresponding to each specified model according to an embodiment of the disclosure.

FIG. 6 is a histogram of a production capacity allocation result according to an embodiment of the disclosure.

### DETAILED DESCRIPTION OF DISCLOSED EMBODIMENTS

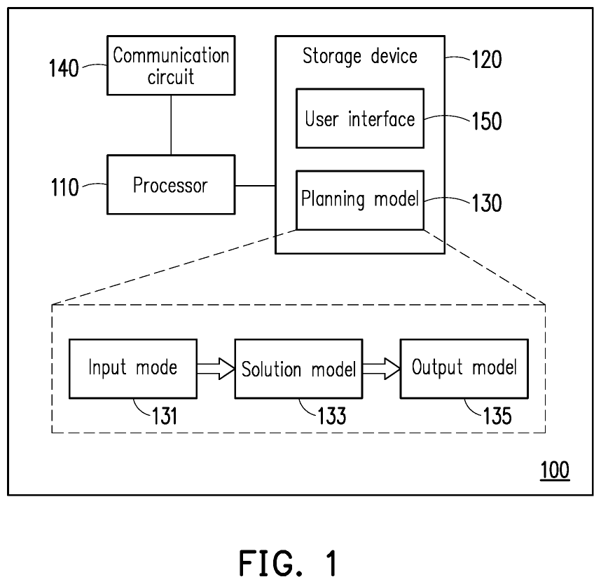

FIG. 1 is a block diagram of a planning apparatus for production capacity allocation according to an embodiment of the disclosure. Please refer to FIG. 1. A planning apparatus 100 is, for example, any electronic apparatus with a computing function, such as a smart phone, a tablet computer, a notebook computer, a personal computer, and a server. The planning apparatus 100 at least includes a processor 110, a storage device 120, and a communication circuit 140.

The processor 110 is, for example, a central processing unit (CPU), a physics processing unit (PPU), a programmable microprocessor, an embedded control chip, a digital signal processor (DSP), an application specific integrated circuits (ASIC), or other similar apparatuses.

The storage device 120 is, for example, any type of fixed or removable random access memory (RAM), read-only memory (ROM), flash memory, hard disk, other similar apparatuses, or a combination of the apparatuses. The storage device 120 includes a planning model 130 and a user interface 150. The planning model 130 and the user interface 150 are composed of one or more code snippets. After the code snippets are installed, the processor 110 executes the following planning method for production capacity allocation.

The planning model 130 includes an input model 131, a solution model 133, and an output model 135. The input model 131 is configured to input all scheduling data and data settings of a production line. The solution model 133 uses a restriction function, a target function, a decision variable, etc. designed by a mathematical model to derive solutions within a reasonable computing time. The output model 135 is configured to output a production capacity allocation result to an output apparatus such as a display.

The communication circuit 140 is, for example, a chip or a circuit that supports communication protocols such as Wi-Fi, third-generation (3G), fourth-generation (4G), and global system for mobile communications. In addition, the communication circuit 140 may also, for example, be a network card. The processor 110 may be connected to other apparatuses via the communication circuit 140.

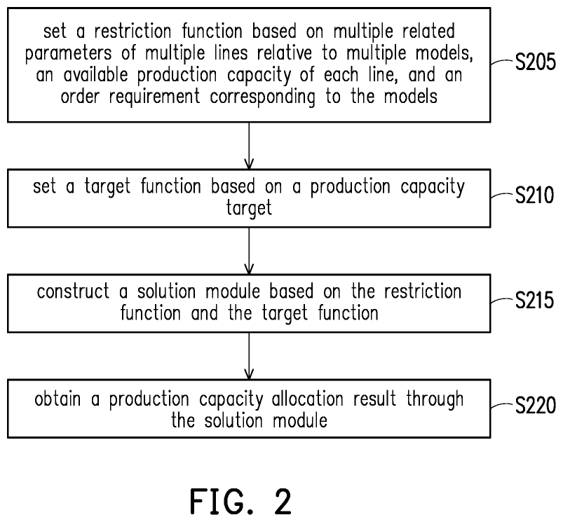

FIG. 2 is a flowchart of a planning method for production capacity allocation according to an embodiment of the disclosure. In the embodiment, an industrial engineer may construct the most suitable solution module 133 through the planning apparatus 100 according to the temporal and spatial background and conditions at the time. Please refer to the following description for details. Please refer to FIG. 2. In Step S205, the planning apparatus 100 sets the restriction function based on multiple related parameters of multiple lines relative to multiple models, an available production capacity of each line, and an order requirement corresponding to the models.

The related parameters include a headcount, a takt time, and an output of each line corresponding to different models. The takt time refers to a ratio of a total effective production time to a customer demand within a certain length of time, such as the time taken for the production line to produce one product. Here, the output is in units of months, that is, the monthly output. The available production capacity includes a production site, a number of pilot run (PR) days, and a number of working days to which each line belongs. Here, the number of pilot run days and the number of working days are, for example, in units of months, that is, the number of monthly pilot run days and the number of monthly working days. The order requirement includes a specified model requested by each customer and a corresponding production capacity forecast. For example, the planning apparatus 100 may collect various data through the user interface 150 or the communication circuit 140, and analyze and sort the received data through a specific system designed to obtain various data required by the restriction function.

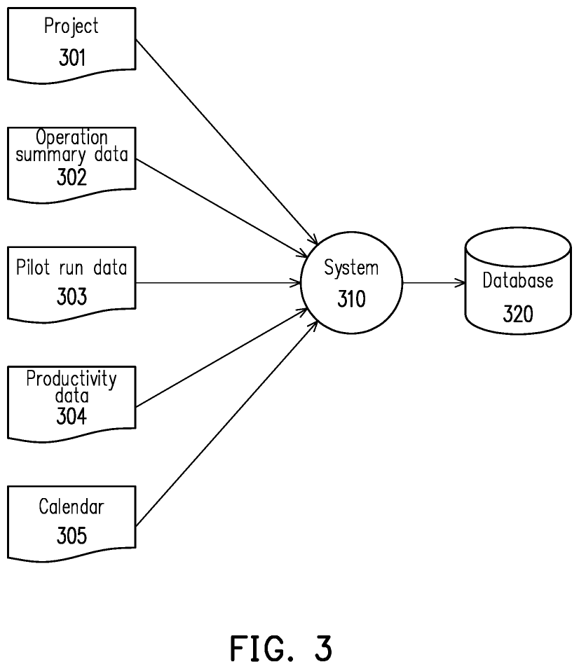

FIG. 3 is a schematic diagram of data consolidation according to an embodiment of the disclosure. Please refer to FIG. 1 and FIG. 3. A system 310 (a software system) may be designed in the storage device 120 in advance to provide the user interface 150 shown in FIG. 1. After that, a project 301, operation (OP) summary data 302, pilot run data 303, productivity data 304, and a calendar 305 obtained via the user interface 150 are uploaded to the system 310. The system 310 filters, summarizes, and matches the various data, and finally stores obtained data (the related parameters of the lines relative to the models, the available production capacity of each line, and the order requirement) to a database 320.

For example, the project 301 records multiple customers and respective requested specified models. The operation summary data 302 includes data of the models, the lines that may produce the models, the production time, the headcount, etc. The pilot run data 303 includes the number of pilot run days corresponding to each model. The productivity data 304 includes the productivity and the number of working days corresponding to the customers. The calendar 305 is configured to predict the number of monthly working days in each month.

The specified model requested by each customer is obtained from the project 301, and the type and the production capacity forecast, that is, the order requirement, that match the specified model are then found in the operation summary data 302. The line correspondingly used by the specified model and the headcount are obtained from the operation summary data 302, and the corresponding takt time and output are calculated based on the line correspondingly used by the specified model and the headcount. The productivity and the number of working days corresponding to each model are obtained from the productivity data 304. The number of pilot run days corresponding to the line correspondingly used by the specified model is obtained from the pilot run data 303.

Table 1 is an example of the order requirement. Table 2 is an example of the related parameters of the lines relative to the models. Table 3 is an example of the available production capacity.

TABLE 1

| Customer | Specified model | Production capacity forecast |
|---|---|---|
| UA | MA_1 | 7500 |
| UA | M_A2 | 1064 |
| UB | M_B1 | 13500 |
| UC | M_C1 | 33768 |
| UC | M_C2 | 32874 |

TABLE 2

| | Specified | | Takt | Headcount | | Produc- |
|---|---|---|---|---|---|---|
| Customer | model | Line | time | requirement | Output | tivity |
| UA | M_A1 | FAC | 40.0 | 23.5 | 40,176 | 0.95 |
| UA | M_A1 | FA2 | 35.0 | 21.5 | 45,915 | 0.00 |
| UA | M_A2 | FA2 | 38.0 | 21.5 | 42,845 | 0.00 |
| UA | M_A2 | FA3 | 42.0 | 18.0 | 38,765 | 0.99 |
| UB | M_B1 | FAC | 45.0 | 23.5 | 36,176 | 0.00 |
| UB | M_B1 | FA2 | 40.0 | 21.5 | 40,698 | 0.96 |
| UB | M_B1 | FA3 | 43.0 | 18.0 | 37,859 | 0.00 |
| UC | M_C1 | FAC | 15.7 | 23.5 | 110,997 | 0.00 |
| UC | M_C1 | FA3 | 18.2 | 18.0 | 95,750 | 0.96 |
| UC | M_C2 | FA2 | 17.1 | 21.5 | 101,338 | 0.96 |
| UC | M_C2 | FA3 | 20.0 | 18.0 | 86,644 | 0.00 |

TABLE 3

| | | Number of pilot | Number of |
|---|---|---|---|
| Production site | Line | run days | working days |
| PA1 | FAC | 0 | 24 |
| PA2 | FA2 | 0 | 26 |
| PA2 | FA3 | 0 | 26 |

After the project 301, the operation summary data 302, the pilot run data 303, the productivity data 304, and the calendar 305 are uploaded to the system 310, if there is a data matching error, the data cannot be found, the line is broken, etc., the system 310 will issue an abnormality prompt message (for example, a prompt window), which is displayed in the user interface 150 for the reference of the user to modify error information until there is no abnormality prompt message before continuing with subsequent actions.

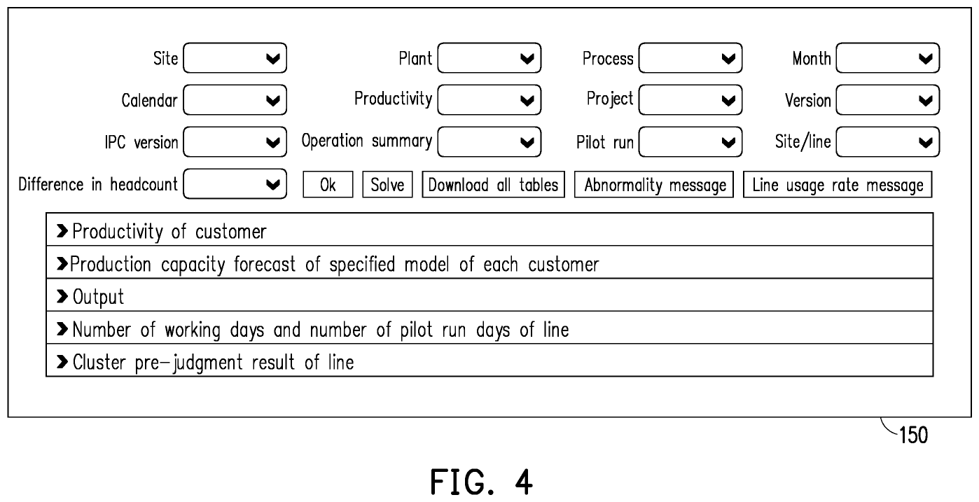

FIG. 4 is a schematic diagram of a user interface according to an embodiment of the disclosure. In FIG. 4, multiple selectable fields in the user interface 150 include site, calendar (corresponding to the calendar 305 of FIG. 3), IPC (industrial personal computer) version, difference in headcount, plant, productivity (corresponding to the productivity data 304 of FIG. 3), operation summary (corresponding to the operation summary data 302 of FIG. 3), process, project (corresponding to the project 301 of FIG. 3), pilot run (corresponding to the pilot run data 303 of FIG. 3), month, version, and site/line (the production site and the corresponding line thereof). Data to be uploaded may be selected in the selectable fields. After the selection is completed, the “OK” button is pressed to upload the data. After the selected data is uploaded, the “Solve” button is pressed to obtain the following data through the processor 110: productivity of customer; production capacity forecast of specified model of each customer; output; number of working days and number of pilot run days of line; and cluster pre-judgment result of line.

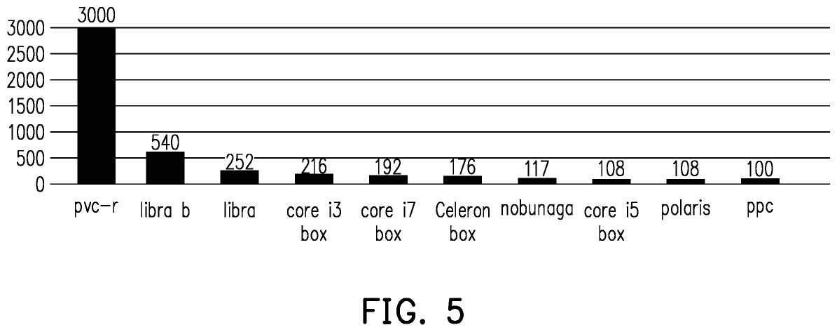

In an embodiment, the production capacity forecast of the specified model of each customer may be presented in the user interface 150 in the form of a histogram. For example, FIG. 5 is a histogram of a production capacity forecast corresponding to each specified model according to an embodiment of the disclosure. FIG. 5 shows the production capacity forecast of multiple specified models respectively produced in the same line, wherein the horizontal axis represents the specified models, and the vertical axis represents the production capacity forecast.

The user interface 150 of FIG. 4 also provides multiple buttons. The “Download all tables” button is pressed to export various results obtained. The “Abnormality message” button is configured to determine whether the abnormality prompt message is generated during the data consolidation stage. The “Line usage rate message” button is configured to display line usage rates of the lines.

The processor 110 sets the restriction function to include a line distribution restriction, an output restriction, and a line usage rate restriction. Specifically, a cluster label is set for each line, wherein the lines belonging to the same cluster label are allowed to open work shifts together. A production allocation quantity produced on the line corresponding to the specified model requested by each customer is set to not exceed the production capacity forecast of the specified model, and a sum of the production allocation quantities of all lines corresponding to the requested specified model is set to be equal to the production capacity forecast. A line usage rate sum of the lines belonging to the same cluster label is set. A largest one among multiple headcounts on the lines belonging to the same cluster label is selected as a headcount representative representing the cluster label.

Returning to FIG. 2, in Step S210, the target function is set based on the production capacity target. Here, the production capacity target includes the minimum production cost. Through the target function, it is ensured that the production capacity allocation result with the “minimum production cost” may be found among tens of thousands of feasible combinations. The minimum production cost includes line headcount minimization or line number of shifts minimization. The production capacity target includes at least one of the highest production efficiency and the highest per capita unit production.

Next, in Step S215, the solution module 133 is constructed based on the restriction function and the target function. After that, in Step S220, the production capacity allocation result is obtained through the solution module 133. The production capacity allocation result corresponds to the order requirement, which includes the line corresponding to the specified model requested by each customer, the headcount of each line, and the number of shifts of each line.

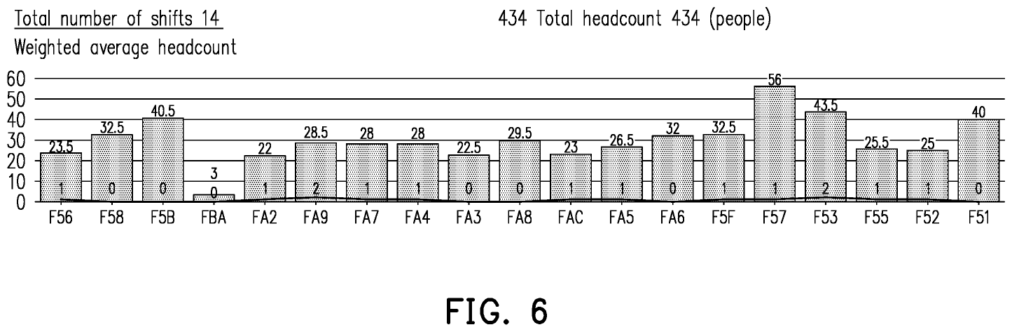

In an embodiment, the production capacity allocation result may be presented in the user interface 150 in the form of a histogram. FIG. 6 is exemplified below for illustration. FIG. 6 is a histogram of a production capacity allocation result according to an embodiment of the disclosure. In the embodiment, the headcount is calculated by weighted average. In the histogram of FIG. 6, the horizontal axis represents the line, the vertical axis represents the weighted average headcount (headcount), and the bars respectively represent different lines. In addition, the corresponding number of shifts is displayed in the histogram corresponding to each line. For a line F56, the weighted average headcount is 23.5, and the corresponding number of shifts is 1 shift. FIG. 6 shows that the result of adding up the number of shifts of the lines is 14 (total number of shifts), and the result of adding up the headcount is 434 people (total headcount).

For example, the production capacity allocation result may include 4 reports. A first report includes the actual number of shifts calculated according to the line usage rate (line usage rate×2). Here, the reason for multiplying the line usage rate by 2 is because there are 2 shifts a day (day shift and night shift). In addition, the first report includes the number of shifts estimated according to the line usage rate. If the line usage rate is between 0 and 0.25, the number of shifts estimated will be 0; if the line usage rate is between 0.25 and 0.75, the number of shifts estimated will be 1; and if the line usage rate is between 0.75 and 1, the number of shifts estimated will be 2.

A second report is configured to present the histogram shown in FIG. 5 and the data shown in Table 4.

TABLE 4

| Line | F56 | F56 | . . . |
|---|---|---|---|
| Specified model | pvc-r | libra_b | . . . |
| Production capacity forecast | 3000 | 540 | . . . |
| Headcount | 23 | 25 | . . . |
| Production quantity per hour | 45 | 14.11 | . . . |
| Estimated production time (hour) | 70.18 | 40.28 | . . . |
| Estimated production time (hour/day) | 9.67 | 9.67 | . . . |
| Number of shifts | 1 | 1 | . . . |
| Number of working days | 7.26 | 4.17 | . . . |
| Proportion (production capacity | 41.29% | 23.70% | . . . |
| forecast/total production capacity) | | | |

A third report (for example, as shown in FIG. 6) records the weighted average headcount corresponding to each line, the number of shifts of each line, and the total number of shifts. The weighted average headcount is calculated as follows:

$${TWHC}_{s} = {\sum }_{i = 1}^{m} {\sum }_{j ∈ {MS}_{i}} {\sum }_{k ∈ {LS}_{ij}} ( {PQ}_{ijks} \cdot {TT}_{ijk} / {PDT}_{i} ) \cdot {HC}_{ijk}$$

$${THOUR}_{s} = {\sum }_{i = 1}^{m} {\sum }_{j ∈ {MS}_{i}} {\sum }_{k ∈ {LS}_{ij}} {PQ}_{ijks} \cdot \frac{{TT}_{ijk}}{{PDT}_{i}}$$

$${GWAHC}_{s} = {TWHC}_{s} / {THOUR}_{s}$$

$$TWAMP = {\sum }_{s = 1}^{K} {\sum }_{v = 2}^{V} {SN}_{v} \cdot {ρ}_{sv} \cdot {GWAHC}_{s}$$

where PDTᵢ is the productivity of a customer i, TWHCₛ is the weighted number of allocated operating people of a cluster label s, THOURₛ is the total production time of the cluster label s, GWAHCₛ is the weighted average headcount of the cluster label s, and TWAMP is the total weighted number of allocated operating people.

A fourth report sorts out the corresponding information according to different customers, so that information such as the output forecast, the number of shifts, and the headcount of each customer may be looked up.

The restriction function and the target function will be described in detail below.

12 restriction functions (1) to (12) and 4 target functions (T1) to (T2) are exemplified below for illustration, but not limited thereto.

The restriction function (1) restricts a line quantity for producing a specified model j of the customer i and does not exceed the total number of a line set LSᵢⱼ suitable for producing the specified model j of the customer i in the entire plant. LSᵢⱼ is a line set of multiple feasible lines for producing the specified model j of the customer i.

Σ_{k∈LS}_{ᵢⱼ}Σₛ₌₁^{K}xᵢⱼₖₛ≤|LSᵢⱼ| (1)

Here, i=1, 2, . . . , m, where i represents the customer, and m is the total number of customers. J represents the specified model, j ∈ MSᵢ, where MSᵢ is the model sets to be produced by the customer i. k represents the line, k ∈ LSᵢⱼ. s is the cluster label, s=1, 2, . . . , K, where K is the total number of clusters. The cluster label s is the basis for identifying whether shifts may be combined. Assuming that a line k1 and a line k2 both belong to the same cluster label s, it represents that the line k1 and the line k2 are allowed to open a work shift together to complete a production task. Accordingly, it is possible to clearly restrict which lines may open a work shift together to facilitate the subsequent integration of production resources and effective use of existing human resources. xᵢⱼₖₛ is the decision variable. When the specified model j of the customer i is determined to be produced on a line k, and the line k belongs to the cluster label s, the decision variable xᵢⱼₖₛ is 1, otherwise the decision variable xᵢₖₖₛ is 0.

The restriction functions (2) and (3) are configured to arrange the specified model j of the customer i to be produced on multiple lines k, but each line may only belong to one cluster label s and may not belong to more than two cluster labels at the same time. The restriction functions (2) and (3) implement the production scheduling and planning conditions of the industrial engineer for the model demand of the customer in actual scenarios.

Σ_{k∈LS}_{ᵢⱼ}Σₛ₌₁^{K}xᵢⱼₖₛ≥1 (2)

Σₛ₌₁^{K}xᵢⱼₖₛ≤1 (3)

The restriction functions (4) and (5) are configured to restrict a production allocation quantity PQᵢⱼₖₛ of the specified model j of the customer i when arranged to be produced on the line k belonging to the cluster label s to not exceed the production capacity forecast of the specified model j of the customer i, and restrict the production allocation quantity PQᵢⱼₖₛ to be greater than or equal to 0.

PQᵢⱼₖₛ≤FQᵢⱼ·xᵢⱼₖₛ (4)

PQᵢⱼₖₛ≥xᵢⱼₖₛ (5)

The restriction function (6) is configured to restrict the total conservation. For the specified model j of the customer i, the sum of the production allocation quantities PQᵢⱼₖₛ produced on each line is equal to a production capacity forecast FQᵢⱼ of the specified model j of the customer i.

Σ_{k∈LS}_{ᵢⱼ}Σₛ₌₁^{K}PQᵢⱼₖₛ=FQᵢⱼ (6)

The restriction functions (7) and (8) are configured to restrict that a total line usage rate (the line usage rate sum) of all lines belonging to the cluster label s can only belong to one line requirement number interval ν. As such, it can be clearly seen which lines may open a work shift together and how many work shifts need to be opened to facilitate the integration of production resources and effective use of existing human resources.

Σₛ₌₁^{K}Σ_{ν=1}^{V}ϕ_{ksν}=1 (7)

Σ_{ν=1}^{C}ρ_{sν}≤1 (8)

Here, ν is the line requirement number interval, ν=1, 2, . . . , V, where V is the total line requirement number interval. ϕ_{ksν} is the decision variable for determining that the line k belongs to the cluster label s and the line requirement number interval is ν, and the decision variable ϕ_{ksν} of 1 is used to determine that the line k belongs to the cluster label s and the line requirement number interval is ν. ρ_{sν} is the decision variable for determining the line requirement number interval ν of the cluster label s, and the decision variable ρ_{sν} of 1 is used to determine that the cluster label s belongs to the line requirement number interval ν.

For example, Table 5 takes a line FAC as an example. In Table 5, based on the value of ϕ_{ksν}, it is determined that the line FAC belongs to the cluster label of 3 and the line requirement number interval of 1. Table 6 is configured to illustrate the decision variable ρ_{sν}. In Table 6, based on the value of ρ_{sν}, it is determined that the line requirement number intervals respectively corresponding to the cluster labels 1, 2, and 3 are 2, 3, and 1.

TABLE 5

| | | Line requirement | |
|---|---|---|---|
| Line (k) | Cluster label (s) | number interval (ν) | ϕₖₛᵥ |
| FAC | 1 | 1 | 0 |
| FAC | 1 | 2 | 0 |
| FAC | 1 | 3 | 0 |
| FAC | 2 | 1 | 0 |
| FAC | 2 | 2 | 0 |
| FAC | 2 | 3 | 0 |
| FAC | 3 | 1 | 1 |
| FAC | 3 | 2 | 0 |
| FAC | 3 | 3 | 0 |

TABLE 6

| | Line requirement | |
|---|---|---|
| Cluster label (s) | number interval (ν) | ρₛᵥ |
| 1 | 1 | 0 |
| 1 | 2 | 1 |
| 1 | 3 | 0 |
| 2 | 1 | 0 |
| 2 | 2 | 0 |
| 2 | 3 | 1 |
| 3 | 1 | 1 |
| 3 | 2 | 0 |
| 3 | 3 | 0 |

The restriction function (9) is a line usage rate restriction function. For the line k, the overall of an output MOPᵢⱼₖ and a number of pilot run days PRDk arranged for the specified model j of the customer i does not exceed a preset value, such as 1.0 (that is, 100%), for a total line usage rate of the line.

Σ_{i∈CS}_{ₖ}Σ_{j∈DS}_{ᵢₖ}PQᵢⱼₖₛ/MOPᵢⱼₖ≤1−PRDₖ/WDₖ (9)

Here, CSₖ represents the customer set that can be produced on the line k, and DSᵢₖ represents the model set of the customer i that can be produced on the line k. WDₖ is the number of working days of the line k. The restriction function (9) may plan scheduling results of mass production models and pilot run models at the same time.

The restriction functions (10) and (11) are interval restriction functions for the line usage rate, which represents that for the line k, the calculated line usage rate can only fall within the line requirement number interval ν. Here, an upper limit value α_{ν} and a lower limit value β_{ν} are set for the line usage rate, and a penalty value M corresponding to the upper limit value and the lower limit value is set at the same time, where M is a maximum positive number.

$${\sum }_{i = 1}^{m} {\sum }_{j ∈ {MS}_{i}} {\sum }_{k ∈ {LS}_{ij}} \frac{{PQ}_{ijks}}{{MOP}_{ijk}} + {\sum }_{k = 1}^{K} {ϕ}_{ksv} \cdot ( \frac{{PRD}_{k}}{{WD}_{k}} ) \geq {ρ}_{sv} \cdot {α}_{v} - ( 1 - {ρ}_{sv} ) \cdot M \qquad ( 10 )$$

$${\sum }_{i = 1}^{m} {\sum }_{j ∈ {MS}_{i}} {\sum }_{k ∈ {LS}_{ij}} \frac{{PQ}_{ijks}}{{MOP}_{ijk}} + {\sum }_{k = 1}^{K} {ϕ}_{ksv} \cdot ( \frac{{PRD}_{k}}{{WD}_{k}} ) \leq {ρ}_{sv} \cdot {β}_{v} - ( 1 - {ρ}_{sv} ) \cdot M \qquad ( 11 )$$

For example, it is set as: when the line requirement number interval ν=1, the upper limit value α₁=0, and the lower limit value β₁=0; when the line requirement number interval ν=2, the upper limit value α₂=0.000001, and the lower limit value β₂=0.500000; when the line requirement number interval ν=3, the upper limit value α₃=0.500001, and the lower limit value β₃=1.000000; and when the demand number interval ν=4, the upper limit value α₄=1.000001, and the lower limit value β₄=1.500000. The restriction functions (10) and (11) may deduce the number of work shifts (number of shifts) that the line will eventually need to open from the result of the line usage rate, as shown in Table 7. Table 7 shows an example of a corresponding relationship between the line requirement number interval ν o and a number of shifts SN_{ν}.

TABLE 7

| Line requirement | Upper | Lower | Number |
|---|---|---|---|
| number interval | limit value | limit value | of shifts |
| (ν) | (α_{ν}) | (β_{ν}) | (SNᵥ) |
| 1 | 0.00 | 0.00 | 0 |
| 2 | 0.01 | 0.50 | 1 |
| 3 | 0.51 | 1.00 | 2 |

The restriction function (12) is a headcount restriction function, which is to find the largest headcount from each line belonging to the cluster label s to serve as the headcount representative representing the cluster label s.

HCᵢⱼₖ·xᵢⱼₖₛ≤MHC_{sν}+(1−ρ_{sν})·M (12)

Here, a headcount HCᵢⱼₖ represents the number of allocated operating people required for the specified model j of the customer i. A largest headcount MHC_{sν} represents the largest number of allocated operating people required for the cluster label s in the line requirement number interval ν. It can be obtained from the restriction function (12) how much headcount is actually required for all lines included in the cluster label s that opens a work shift together to complete the production task of the cluster label s.

The target function (T1) is for line headcount minimization, which may obtain (find) a production capacity allocation result with the minimum production cost from various feasible results in the case where various supply and demand restrictive conditions are satisfied.

Min Σₛ₌₁^{K}Σ_{ν=2}^{V}SN_{ν}·MHC_{sν}+M·Σₖ₌₁^{K}(μₖ+πₖ+αₖ) (T1)

Here, SN_{ν} represents the number of shifts corresponding to the line requirement number interval ν. For example, it is set as: when the line requirement number interval ν=1, SN₁=0; when the line requirement number interval ν=2, SN₂=1; when the line requirement number interval ν=3, SN₃=2; and when the line requirement number interval ν=4, SN₄=3. μₖ represents the tolerance factor of the line requirement number interval of the line k, πₖ represents the tolerance factor of the upper limit value of the line requirement number interval of the line k, and σₖ represents the tolerance factor of the lower limit value of the line requirement number interval of the line k.

The target function (T2) is for number of work shifts minimization of a production line, which may obtain (find) a production capacity allocation result with the minimum production cost from various feasible results in the case where various supply and demand restriction functions are satisfied.

Min Σₛ₌₁^{K}Σ_{ν=2}^{V}SN_{ν}·ρ_{sν}+M·Σₖ₌₁^{K}(μₖ+πₖ+αₖ) (T2)

The target function (T3) is for shortening of total time required for production, which may obtain (find) a production capacity allocation result with the highest production efficiency from various feasible results in the case where various supply and demand restriction functions are satisfied. Here, TTᵢⱼₖ represents the takt time corresponding to the specified model j of the customer i on the line k.

Min{Σᵢ₌₁^{m}Σ_{j∈MS}_{ᵢ}Σ_{k∈LS}_{ᵢ}Σₛ₌₁^{K}PQᵢⱼₖ·TTᵢⱼₖ+M·Σₖ₌₁^{K}(μₖ+πₖ+αₖ)} (T3)

The target function (T4) is the highest per capita unit output, which may obtain (find) a production capacity allocation result with the highest per capita unit output from various feasible results in the case where various supply and demand restriction functions are satisfied.

Max{Σᵢ₌₁^{m}Σ_{j∈MS}_{ᵢ}Σ_{k∈LS}_{ᵢ}Σₛ₌₁^{K}(1/TTᵢⱼₖ·HCᵢⱼₖ)·xᵢⱼₖₛ−M·Σₖ₌₁^{K}(μₖ+πₖ+αₖ)} (T4)

The target function (T1) to the target function (T4) enable the industrial engineer to select at least one target function that conforms to the current situation the most according to the temporal and spatial background and conditions at the time to construct the solution module 133, and finally obtain the production capacity allocation result that conforms to the target function.

In the embodiment, tolerance factors μₖ, πₖ, and σₖ are also introduced to speed up the overall solving efficiency of the solution module 133. The solution takes about 10 seconds, which can meet the expectation of the industrial engineer to find the optimal planning combination as soon as possible when performing the planning task.

For example, the tolerance factor μₖ is set for the restriction function (9) to obtain the following tolerance function (L1). Here, LQUB is the upper limit value, for example, 1.0, of the line usage rate. The tolerance function (L1) allows adaptation to exceed the upper limit value of 1.0 during a solving process to speed up the finding of a feasible solution and speed up a convergence range. However, relatively when the tolerance value μₖ is greater than zero, the corresponding penalty value M is synchronously derived from the target function to affect the optimal value of the target function.

$${\sum }_{i ∈ {CS}_{k}} {\sum }_{j ∈ {DS}_{ik}} {\sum }_{s = 1}^{K} \frac{{PQ}_{ijks}}{{MOP}_{ijk}} + \frac{{PRD}_{k}}{{WD}_{k}} \leq LQUB + {μ}_{k} \qquad ( L1 )$$

From the result, a line whose usage rate is greater than the upper limit value of 1.0 is found, and the abnormality prompt message is issued to remind the user to re-adjust related data such as the corresponding data of multiple models in the operation summary data 302, the lines that may produce the models, the production time, and the headcount, so that the industrial engineer may quickly analyze whether the production capacity forecast of the models and the output of the lines match for the lines, adjust basic data such as the production capacity or the takt time accordingly, and reuse the solution module 133 to re-solve. This can save the industrial engineer from having to blindly try and error to find the reason for having no feasible solution from a large amount of line data when the solution module 133 shows that there is no feasible solution.

The tolerance function (L2) and the tolerance function (L3) are designed for an upper limit value ALQUB and a lower limit value ALQLB of the line usage rate. The tolerance factors πₖ and σₖ are respectively added to the upper limit value ALQUB and the lower limit value ALQLB of the line usage rate of the line k to allow adaptation to exceed the upper and lower limit values of the line usage rate during the solving process, thereby speeding up the finding of the feasible solution and speeding up the convergence range. In contrast, when the tolerance factors πₖ and σₖ are greater than 0, the corresponding penalty value is synchronously derived from the target function to affect the optimal value of the target function.

$${\sum }_{i ∈ {CS}_{k}} {\sum }_{j ∈ {DS}_{ik}} {\sum }_{s = 1}^{K} \frac{{PQ}_{ijks}}{{MOP}_{ijk}} + \frac{{PRD}_{k}}{{WD}_{k}} \leq ALQUB + {π}_{k} \qquad ( L2 )$$

$${\sum }_{i ∈ {CS}_{k}} {\sum }_{j ∈ {DS}_{ik}} {\sum }_{s = 1}^{K} \frac{{PQ}_{ijks}}{{MOP}_{ijk}} + \frac{{PRD}_{k}}{{WD}_{k}} \geq ALQUB - {σ}_{k} \qquad ( L3 )$$

k ∈ ALS, where ALS represents the set of automated lines to facilitate a special design of the automated lines.

Accordingly, through the relationship and influence between the target functions, the restriction functions, and the tolerance factors, the solution module 133 can be ensured to find the optimal production capacity allocation result in a very short time. Experiments have confirmed that compared with before the tolerance factors are introduced, the solution module 133 with the tolerance factors introduced may speed up the solving efficiency by 42% to 93%.

The solution module 133 of the disclosure, for example, adopts a mixed integer linear programming (MILP) model. After the user completes data input, an application programming interface (API) automatically calls a solving engine to perform planning and solving. The solving engine is, for example, a CPLEX optimizer. The solving engine uses a branch-and-cut algorithm as the main architecture to solve the model. The branch-and-cut algorithm splits an original problem into multiple independent sub-problems, and uses an original primal/dual simplex algorithm to solve the sub-problems with linear programming relaxation. After the optimal solution is obtained, if there is a decision variable that is restricted to an integer but has a non-integer value, a cutting plane method is used to further derive a linear restriction function to be added to the current issue of linear programming relaxation, so that the solution obtained by the next iteration may be closer to the result of an integer.

The existing CPLEX optimizer may further optimize the solving efficiency through pre-solving, branching strategy, search strategy (for example, depth-first, breadth-first, and best-first), heuristics, etc.

The CPLEX optimizer provides a web application, a web API application, and an API application. The web application is configured to provide the user interface 150 (as shown in FIG. 1 and FIG. 4). The web API application is configured to provide all functions other than solution-related functions for triggering the CPLEX optimizer. For example, a user login function is configured to authenticate and authorize a user; a user maintenance function is configured to create an account and set authorization; a data maintenance function is configured to maintain basic data; an API call function is configured to trigger the API application to continue optimizing the solution; and a result query function is configured to query and present an optimized result.

The API application is configured to provide the solution-related functions. For example, an API application interface is configured to provide an interface for an external API call; a data creation function is configured to create a data model required by the CPLEX optimizer; a trigger interface function is configured to trigger optimizing the solution; and a solution result analysis function is configured present an optimized solution result.

Tables 8 to 10 are examples of solution results (production capacity allocation results).

TABLE 8

| | | | Cluster | Decision | Production |
|---|---|---|---|---|---|
| Customer | Specified | Line | label | variable | allocation quantity |
| (i) | model (j) | (k) | (s) | (xᵢⱼₖₛ) | (PQᵢⱼₖₛ) |
| UA | M_A1 | FAC | 1 | 0 | 0 |
| UA | M_A1 | FAC | 2 | 0 | 0 |
| UA | M_A1 | FAC | 3 | 0 | 0 |
| UA | M_A1 | FA2 | 1 | 1 | 7500 |
| UA | M_A1 | FA2 | 2 | 0 | 0 |
| UA | M_A1 | FA2 | 3 | 0 | 0 |
| UA | M_A2 | FA2 | 1 | 1 | 1064 |
| UA | M_A2 | FA2 | 2 | 0 | 0 |
| UA | M_A2 | FA2 | 3 | 0 | 0 |
| UA | M_A2 | FA3 | 1 | 0 | 0 |
| UA | M_A2 | FA3 | 2 | 0 | 0 |
| UA | M_A2 | FA3 | 3 | 0 | 0 |
| UB | M_B1 | FAC | 1 | 0 | 0 |
| UB | M_B1 | FAC | 2 | 0 | 0 |
| UB | M_B1 | FAC | 3 | 0 | 0 |
| UB | M_B1 | FA2 | 1 | 0 | 0 |
| UB | M_B1 | FA2 | 2 | 0 | 0 |
| UB | M_B1 | FA2 | 3 | 0 | 0 |
| UB | M_B1 | FA3 | 1 | 0 | 0 |
| UB | M_B1 | FA3 | 2 | 1 | 13500 |
| UB | M_B1 | FA3 | 3 | 0 | 0 |
| UC | M_C1 | FAC | 1 | 0 | 0 |
| UC | M_C1 | FAC | 2 | 0 | 0 |
| UC | M_C1 | FAC | 3 | 0 | 0 |
| UC | M_C1 | FA3 | 1 | 0 | 0 |
| UC | M_C1 | FA3 | 2 | 1 | 33768 |
| UC | M_C1 | FA3 | 3 | 0 | 0 |
| UC | M_C2 | FA2 | 1 | 1 | 9449 |
| UC | M_C2 | FA2 | 2 | 0 | 0 |
| UC | M_C2 | FA2 | 3 | 0 | 0 |
| UC | M_C2 | FA3 | 1 | 0 | 0 |
| UC | M_C2 | FA3 | 2 | 1 | 23425 |
| UC | M_C2 | FA3 | 3 | 0 | 0 |

Table 8 includes allocation results of specified models requested by each customer corresponding to multiple lines. For a specified model MA_A1 of a customer UA, a line used is FA2 (determined by the decision variable), which belongs to a cluster label 1, and the production allocation quantity is 7,500.

TABLE 9

| Customer | Specified | Line | Production allocation | Takt time |
|---|---|---|---|---|
| (i) | model (j) | (k) | quantity (PQᵢⱼₖₛ) | (TTᵢⱼₖ) |
| UA | M_A1 | FA2 | 7500 | 35.0 |
| UA | M_A2 | FA2 | 1064 | 38.0 |
| UB | M_B1 | FA3 | 13500 | 43.0 |
| UC | M_C1 | FA3 | 33768 | 18.2 |
| UC | M_C2 | FA2 | 9449 | 17.1 |
| UC | M_C2 | FA3 | 23425 | 20.0 |

Table 9 is an example of production capacity allocation results obtained based on Table 8. That is, Table 9 is generated based on the results of the decision variable being 1 in Table 8.

TABLE 10

| Cluster label (s) of combined shifts | 1 | 2 | 3 |
|---|---|---|---|
| Line quantity of combined shifts | 1 | 1 | 1 |
| Line of combined shifts | {“FA2”} | {“FA3”} | {“FAC”} |
| Largest headcount | 21.5 | 18 | 23.5 |
| Line requirement number | 2 | 3 | 1 |
| interval (ν) | | | |
| Number of shifts SNᵥ | 1 | 2 | 0 |
| Largest headcount × SNᵥ | 21.5 | 36 | 0 |

| | |
|---|---|
| Total number of shifts | 3 |
| Total headcount | 58 (57.5 rounded up to an integer) |

Table 10 shows integrated results of combined shifts. For a line FA2, the largest headcount is 21.5, and the number of shifts required is 1 shift. Therefore, the headcount corresponding to the line FA2 is 21.5×1=21.5. For a line FA3, the largest headcount is 18, and the number of shifts required is 2. Therefore, the headcount corresponding to the line FA3 is 18×2=36. The number of shifts of the line FAC is 0, so there is no headcount for the line. After that, the total headcount of the three lines is 21.5+36+0. Data in Table 10 may also be further presented as a histogram. For example, the histogram shown in FIG. 6 is presented.

In summary, the disclosure can promptly re-plan and solve to improve service standards in response to changes in the order requirement or related specified production conditions.

Experimental results show that the disclosure can calculate the optimal solution within an average of 30 seconds for production planning with extremely high combination complexity, and save 99.7% of the planning time for the industrial engineer. That is, the current manual planning takes 4 hours, but the planning using the disclosure takes an average of 30 seconds, so the improvement margin is 99.7%. Accordingly, the time for manual repeated maintenance of data can be reduced, and manual errors caused by manual maintenance can also be avoided to improve the accuracy of production capacity planning by the disclosure. In addition, the disclosure automatically verifies whether the data is abnormal during the data maintenance stage, so any data error in the subsequent solving process will not invalidate the final result.

What is claimed is:

1. A planning method for production capacity allocation, executed through a processor, the planning method comprising:
setting a restriction function based on a plurality of related parameters of a plurality of lines relative to a plurality of models, an available production capacity of each of the lines, and an order requirement corresponding to the models;
setting a target function based on a production capacity target, wherein the production capacity target comprises a minimum production cost;
constructing a solution module based on the restriction function and the target function; and
obtaining a production capacity allocation result through the solution module, wherein the production capacity allocation result comprises a line corresponding to a specified model, a headcount of each of the lines, and a number of shifts of each of the lines.

2. The planning method for production capacity allocation according to claim 1, wherein the related parameters comprise a headcount, a takt time, and an output of each of the lines corresponding to different models, the available production capacity comprises a production site to which each of the line belongs, a number of pilot run days, and a number of working days, the order requirement comprises the requested specified model and a corresponding production capacity forecast, and
the restriction function comprises a line distribution restriction, an output restriction, and a line usage rate restriction.

3. The planning method for production capacity allocation according to claim 2, wherein before setting the restriction function, the planning method further comprises:
obtaining a project, operation summary data, pilot run data, and productivity data via a user interface or a database;
obtaining the requested specified model from the project, and obtaining the production capacity forecast corresponding to the specified model from the operation summary data based on the specified model;
obtaining a line correspondingly used by the specified model and the headcount from the operation summary data, and calculating the corresponding takt time and the output based on the line correspondingly used by the specified model and the headcount;
obtaining a productivity and the number of working days corresponding to each of the models from the productivity data; and
obtaining the number of pilot run days corresponding to the line correspondingly used by the specified model from the pilot run data.

4. The planning method for production capacity allocation according to claim 1, wherein the minimum production cost comprises line headcount minimization or line number of shifts minimization.

5. The planning method for production capacity allocation according to claim 1, wherein the production capacity target further comprises at least one of a highest production efficiency and a highest per capita unit production.

6. The planning method for production capacity allocation according to claim 1, further comprising:
introducing at least one tolerance factor into the restriction function, and setting a corresponding penalty value in the target function.

7. The planning method for production capacity allocation according to claim 1, wherein the step of setting the restriction function further comprises:
setting a cluster label for each of the lines, wherein the lines belonging to a same cluster label are allowed to open a work shift together;
setting a production allocation quantity produced on each of the lines corresponding to the requested specified model to not exceed a production capacity forecast of the specified model, and a sum of the production allocation quantities of all of the lines corresponding to the requested specified model to be equal to the production capacity forecast;
setting a line usage rate sum of the lines belonging to the same cluster label; and
setting to select a largest one among a plurality of headcounts on the lines belonging to the same cluster label as a headcount representative representing the cluster label.

8. The planning method for production capacity allocation according to claim 1, wherein the step of setting the restriction function further comprises:
calculating a line usage rate of each of the lines according to a production capacity forecast; and
in response to the line usage rate is greater than a preset value, issuing an abnormality prompt message.

9. A planning apparatus for production capacity allocation, comprising:
a storage device, comprising a database, wherein the database stores a plurality of related parameters of a plurality of lines relative to a plurality of models, an available production capacity of each of the lines, and an order requirement corresponding to the models; and
a processor, coupled to the storage device, wherein the processor is configured to:
set a restriction function based on the related parameters, the available production capacity of each of the lines, and the order requirement;
set a target function based on a production capacity target, wherein the production capacity target comprises a minimum production cost;
construct a solution module based on the restriction function and the target function; and
obtain a production capacity allocation result through the solution module, wherein the production capacity allocation result comprises a line corresponding to a specified model, a headcount of each of the lines, and a number of shifts of each of the lines.

10. The planning apparatus according to claim 9, wherein the related parameters comprise a headcount, a takt time, and an output of each of the lines corresponding to different models, the available production capacity comprises a production site to which each of the line belongs, a number of pilot run days, and a number of working days, the order requirement comprises the requested specified model and a corresponding production capacity forecast, and
the restriction function comprises a line distribution restriction, an output restriction, and a line usage rate restriction.

11. The planning apparatus according to claim 10, wherein the storage device further comprises providing a user interface, and the processor is configured to:
obtain a project, operation summary data, pilot run data, and productivity data via the user interface;
obtain the requested specified model from the project, and obtain the production capacity forecast corresponding to the specified model from the operation summary data based on the specified model;
obtain a line correspondingly used by the specified model and the headcount from the operation summary data, and calculate the corresponding takt time and the output based on the line correspondingly used by the specified model and the headcount;
obtain a productivity and the number of working days corresponding to each of the models from the productivity data; and
obtain the number of pilot run days corresponding to the line correspondingly used by the specified model from the pilot run data.

12. The planning apparatus according to claim 9, wherein the minimum production cost comprises line headcount minimization or line number of shifts minimization.

13. The planning apparatus according to claim 9, wherein the production capacity target further comprises at least one of a highest production efficiency and a highest per capita unit production.

14. The planning apparatus according to claim 9, wherein the restriction function comprises a line usage rate restriction, and the processor is configured to:
introduce at least one tolerance factor into the restriction function, and set a corresponding penalty value in the target function.

15. The planning apparatus according to claim 9, wherein the processor is configured to:
set a cluster label for each of the lines, wherein the lines belonging to a same cluster label are allowed to open a work shift together;
set a production allocation quantity produced on each of the lines corresponding to the requested specified model to not exceed a production capacity forecast of the specified model, and a sum of the production allocation quantities of all of the lines corresponding to the requested specified model to be equal to the production capacity forecast;
set a line usage rate sum of the lines belonging to the same cluster label; and
set to select a largest one among a plurality of headcounts on the lines belonging to the same cluster label as a headcount representative representing the cluster label.

16. The planning apparatus according to claim 9, wherein the processor is configured to:
calculate a line usage rate of each of the lines according to a production capacity forecast; and
in response to the line usage rate is greater than a preset value, issue an abnormality prompt message.

17. A planning method for production capacity allocation, executed through a processor, the planning method comprising:
providing a plurality of selectable fields via a user interface to obtain a plurality of data from the selectable fields, wherein the data comprise a plurality of related parameters of a plurality of lines relative to a plurality of models, an available production capacity of each of the lines, an order requirement corresponding to the models, and a production capacity target; and
displaying a production capacity allocation result corresponding to the obtained data through the user interface, wherein the production capacity allocation result comprises a line corresponding to a specified model, a headcount of each of the lines, and a number of shifts of each of the lines,
after obtaining the data via the user interface, executing following steps through the processor:
setting a restriction function based on the related parameters, the available production capacity, and the order requirement;
setting a target function based on the production capacity target, wherein the production capacity target comprises a minimum production cost;
constructing a solution module based on the restriction function and the target function; and
obtaining the production capacity allocation result through the solution module.

18. The planning method for production capacity allocation according to claim 17, wherein the restriction function comprises a line distribution restriction, an output restriction, and a line usage rate restriction, and
the production capacity target further comprises at least one of a highest production efficiency and a highest per capita unit production.

19. The planning method for production capacity allocation according to claim 17, further comprising:
introducing at least one tolerance factor into the restriction function, and setting a corresponding penalty value in the target function.

20. The planning method for production capacity allocation according to claim 17, further comprising:
in response to a line usage rate is greater than a preset value, issuing an abnormality prompt message through the user interface, wherein the processor calculates the line usage rate of each of the lines according to a production capacity forecast.
